(19) United States
(12) Patent Application Publication
(10) Pub. No.: US 2011/0082666 A1
(43) Pub. Date: Apr. 7, 2011

(54) Numerical Engineering Model System And Accessing Method Thereof

(76) Inventors: Wen-Chih Chen, Taipei (TW); Szu-Hsien Ho, Taipei (TW); Ping-Hsing Ho, Taipei (TW); Chih-Wei Cheng, Taipei (TW)

(21) Appl. No.: 12/572,269

(22) Filed: Oct. 2, 2009

(51) Int. Cl. G06F 17/50

(52) U.S. Cl. 703/1

(57) ABSTRACT

A numerical engineering model system is installed in a computer server and remotely operated by a local device via a network, which includes a user interface showing an operating page and receiving the numerical parameters, an analyzing module having at least one engineering model presented as the numerical parameters and a corresponding picture, a database storing the inputted numerical parameters and the picture, an engineering software means processing the inputted numerical parameters, and building, simulating and analyzing a 2D/3D model, and then storing the 2D/3D model, a simulating result and an analyzing result in the database. It is convenient for the users to remotely operate the system via any computer with network function. It simplifies the design procedures and reduces the design cost and design time because the engineering model is presented as numerical parameters and the corresponding picture. Furthermore, it is easy to understand and operate by common users without engineering knowledge.

### BACKGROUND OF THE INVENTION

1. Field of the Invention

The present invention relates to a numerical engineering model system, more specifically, to a method for remotely accessing the numerical engineering model system.

2. The Related Art

Many engineering software becomes popular nowadays, such as computer aided design software (CAD) and computer aided engineering software (CAE). The users can design a virtual 2D/3D model by operating CAD software. Then, the users can analyze the structural characteristic and the electrical characteristic of the 2D/3D model.

Hence, the user can re-build and re-simulate a virtual product corresponding to a physical product via the CAD/CAE software to replace conventional procedures of retrying to make physical simples. Therefore, the CAD/CAE software can reduce developing time and cost of the product.

However, the conventional CAD/CAE software has the following drawbacks. The conventional CAD/CAE software is installed in a standalone computer. On the one hand, it is not convenient for the users to carry such standalone computer. On the other hand, it is inconvenient for training the users to operate the CAE/CAD software because the simulating results of each virtual product via the CAE software are stored as a separated file in the computer. It is not convenient to manage all the simulating result.

### SUMMARY OF THE INVENTION

An object of the present invention is to provide a numerical engineering model system capable of simplifying the design procedures and reducing the design cost and the design time.

According to the invention, the numerical engineering model system is installed in computer server and remotely operated by a local device via a network linking the computer server and the local device. The numerical engineering model system has a user interface, an analyzing module, a database and an engineering software means.

The user interface shows an operating page by an output apparatus of the local device and receiving numerical parameters inputted by an input apparatus of the local device. The analyzing module has at least one engineering model represented as the numerical parameters and a corresponding picture. The database is called by the analyzing module for storing the inputted numerical parameters and the picture.

The engineering software means is called by the analyzing module for processing the inputted numerical parameters. The engineering software means builds one of a 2D model and a 3D model, and simulates and analyzes one of the 2D model and the 3D model. Then, the engineering software means stores the 2D model, the 3D model, a simulating result and an analyzing result in the database.

An object of the present invention is to provide a method of accessing the numerical engineering model system.

According to the invention, the method comprises steps of: linking with the computer server via the local device; login the numerical engineering model system by an account means for judging an authority of a login user; showing an user the interface means via an output apparatus of the local device; inputting the numerical parameters to the user interface means via the input apparatus of the local device, the numerical parameters representing the structure of an engineering model; storing the inputted numerical parameters in the database; building at least one of the 2D model and the 3D model based on the inputted numerical parameters by the engineering software means; simulating and analyzing at least one of the 2D model and the 3D model by the engineering software means; processing the simulating result and the analyzing result by the engineering software means; and storing the simulating result and the analyzing result in the database.

Because the numerical engineering model system is linked to the network, it is convenient for the users to remotely operate the numerical engineering model system via any computer with network function. The engineering model is presented as numerical parameters and corresponding picture to simplify design procedures and reduce design cost and design time. Furthermore, it is easy to understand and operate by common users without engineering knowledge.

### BRIEF DESCRIPTION OF THE DRAWINGS

The present invention will be apparent to those skilled in the art by reading the following description of preferred embodiments thereof, with reference to the attached drawings, in which:

FIG. 1 shows a numerical engineering model system installed in a computer server of a network according to the present invention;

FIG. 2 shows a block diagram of a first preferred embodiment of the numerical engineering model system according to the present invention;

FIG. 3 is a user interface module showing a account module, a material module, a report module and an analyzing module of the numerical engineering model system according to the present invention;

FIG. 4 is the user interface showing details of the analyzing module of the numerical engineering model system according to the present invention;

FIG. 5 shows a block diagram of a second preferred embodiment of the numerical engineering model system according to the present invention; and

FIG. 6 shows a block diagram of a third preferred embodiment of the numerical engineering model system according to the present invention.

### DETAILED DESCRIPTION OF THE PREFERRED EMBODIMENT

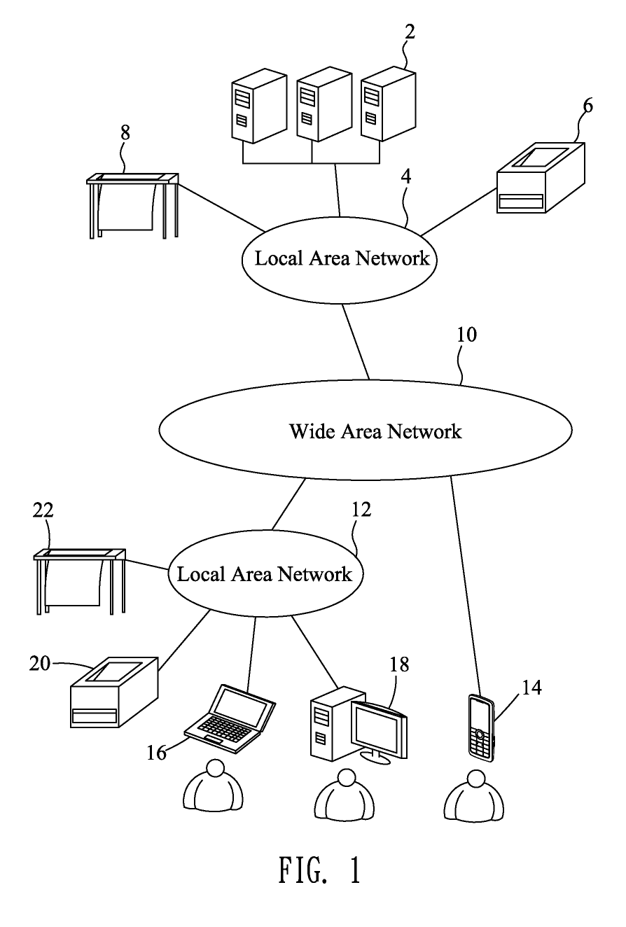

Please refer to FIG. 1. A preferred embodiment of numerical engineering model system 1 is installed in a computer server 2 of a network. Users can operate an electrical device to link the computer server 2 for remotely accessing the numerical engineering model system 1. The network may be an internet network, a PSTN network, a point-to-point link, GSM network, etc. In this embodiment, the computer server 2 consists of a plurality of computer hosts which comply with pipe-line processing system. Furthermore, the computer server 2 may be a multi-core computer host.

The computer server 2 links to a first local area network 4 (LAN). The first LAN 4 further links to a first printer 6 and a first plotter 8. A simulating report of the numerical engineering model system 1 may stored in a database in the computer server 2 and may be sent to the first printer 6 and a first plotter 8 via the first LAN 4 to print out. Moreover, the first printer 6 and the first plotter 8 can directly connect to the computer server 2.

The first LAN 4 links to a second LAN 12 and a first local device 14 via a wide area network 10 (WAN), such as internet network, PSTN network, GSM network, etc. The second LAN 12 links a second local device 16, a third local device 18, a second printer 20 and a second plotter 22. In this embodiment, the first local device 14 is a mobile phone, the second local device 16 is a laptop, and the third local device 18 is a standalone computer.

The first local device 14, the second local device 16 and the third local device 18 can simultaneously link to the computer server 2 via the WAN 10 and operates the numerical engineering model system 1. The numerical engineering model system 1 can simultaneously processes the links and operations and produces corresponding simulating reports by multi-thread function.

The corresponding simulating reports are sent from the numerical engineering model system 1 to the first local device 14, the second local device 16 and the third local device 18 respectively. The simulating reports may be sent to the second printer 20 and the second plotter 22 to print out. Furthermore, the second printer 20 and the second plotter 22 can directly connect to one of the first local device 14, the second local device 16 and the third local device 18.

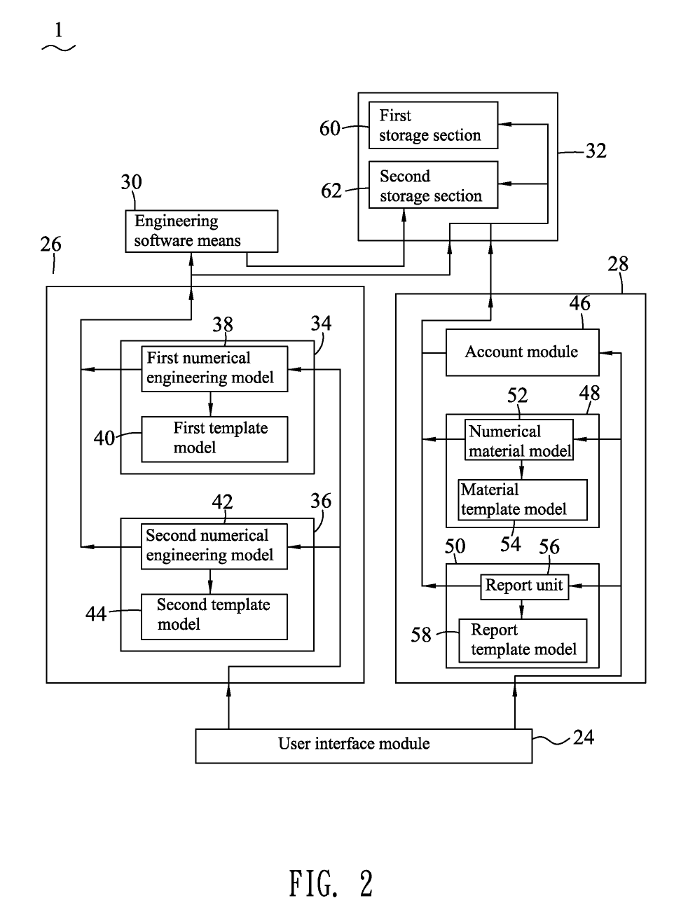

Please refer to FIG. 2, it shows a block diagram of a first preferred embodiment of the numerical engineering model system 1. The numerical engineering model system 1 has a user interface module 24, an analyzing module 26, managing module 28, an engineering software means 30 and a database 32. The analyzing module 26 has a first engineering module 34 and a second engineering module 36. The first engineering module 34 has a first numerical engineering model 38 and a first temple model 40. The second engineering module 36 has a second numerical engineering model 42 and a second template model 44.

The managing module has 28 a account module 46, a material module 48 and a report module 50. The material module 48 has a numerical material model 52 and a material template model 54. The report module 50 has a report unit 56 and a report template model 58. The database 32 has a first storage section 60 and a second storage section 62.

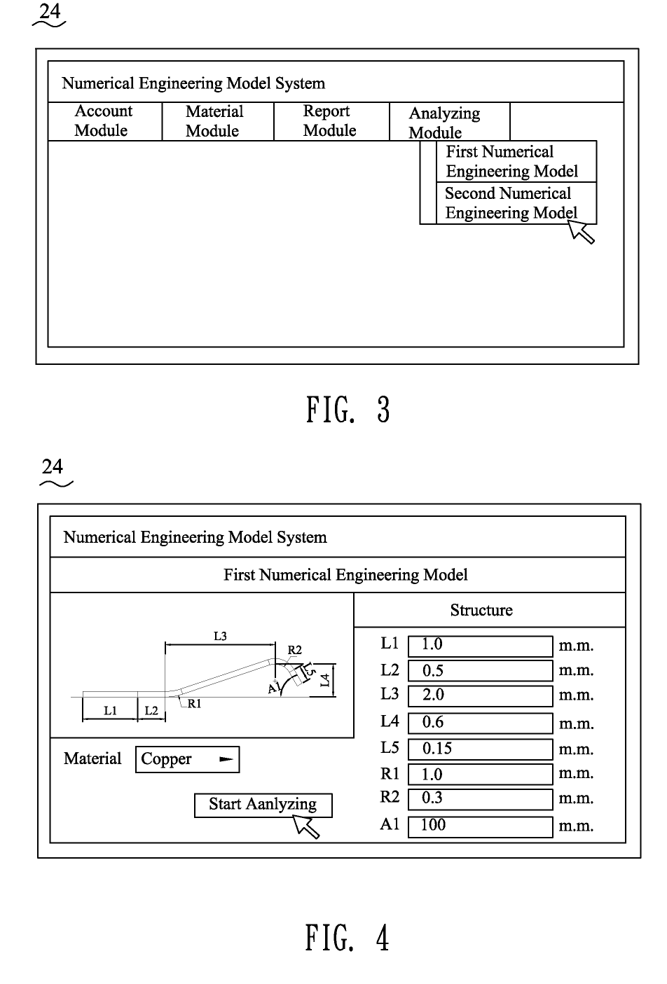

Please refer to FIG. 3 which is the user interface module 24 showing the account module 46, the material module 48, the report module 50 and the analyzing module 26. The method of accessing the numerical engineering model system 1 has following steps.

The first local device 14, the second local device 16 and the third local device 18 simultaneously link to the numerical engineering model system 1 installed in the computer server 2 via the WAN 10. The user interface module 24 shows a login page via corresponding displays of the local device 14, 16, 18 to require an account and the corresponding password. The user inputs the account and password via corresponding input devices of the local device 14, 16, 18, which is acquired by the user interface module 24 and sent to the account module 46.

The account module 46 compares the login account and password with the accounts and corresponding password stored in the database 32 to judge the authority of the login user. If the login user is not accepted, then the user interface module 24 will show a warning message and return to the login page. If the login user is accepted, then the user interface module 24 will show an operating page. The user can select and operate the analyzing module 26, the material module 48 and the report module 50 via the operating page.

If the user selects the analyzing module 26, then the user interface module 24 will produce a new page showing the first engineering module 34 and the second engineering module 36 built in the numerical engineering model system 1. In this embodiment, the first engineering module 34 is a terminal model of an electrical connector and the second engineering module 36 is an isolated housing model of the electrical connector.

If the user selects the first engineering module 34, then the user interface module 24 will call the first numerical engineering model 38. The first numerical engineering model 38 comprises structure characteristics of the terminal of the electrical connector and a corresponding picture. The structure characteristics, such as the length, the thickness, the curvature, the material, etc, are represented as numerical parameters. The first numerical engineering model 38 acquires the default parameters and a default picture stored in the database 32 and calls the first template model 40.

The first template model 40 comprises an exclusive template showing the positions of the parameters of the structure characteristics and the picture of the terminal. The first numerical engineering model 38 combines the default parameters and the default picture with the exclusive template as a whole page. Then, the user interface module 24 shows the whole page as shown in FIG. 4.

The user can amend the new parameters and select a new material according to a new design via the user interface module 24. If the user act an icon of start analyzing, then the first numerical engineering model 38 will store the amended parameters in the database 32 and call the engineering software means for building a new 2D/3D model of the terminal and further simulating and analyzing the new 2D/3D model of the terminal.

The first numerical engineering model 38 monitors the status of the simulating and analyzing produce and then stores simulating report in the database 32. The report module 50 can shows all simulating reports and formats the simulating report into a selected file format, such as a text file, a figure file, a html file and a combination thereof.

If the report module 50 is selected via the user interface module 24, then the user interface module 24 will call the report unit 56. The report unit 56 acquires all simulating reports stored in the database 32, which comprises the amended parameters, a 2D/3D model picture, a curve of the structure characteristics, etc. Then, the report unit 56 calls the report template model 58.

The report template model 58 comprises an exclusive template showing the positions of all the simulating reports. The report unit 56 combines all the simulating reports with the exclusive template as a whole page. Then, the user interface module 24 shows the whole page. The report unit also sends the simulating reports to the printers 6, 20 and the plotters 8, 22 to print the simulating reports on papers.

If the material module 48 is selected via the user interface module 24, then the user interface module 24 will call the report unit 56. The report unit 56 acquires the simulating reports stored in the database 32, which comprises the amended parameters, a 2D/3D model picture, a curve of the structure characteristics, etc. Then, the report unit 56 calls the report template model 58.

The users can access and amend the parameters of material characteristics stored in the database 32 via the material module 48, if the material module 48 is selected and acted. If the material module 48 is selected, the numerical material model 52 is acted. The numerical material model 52 acquires the titles of materials and the corresponding parameters of characteristics, which are stored in the database 32. For instance, the titles of materials comprise copper, iron, gold, etc. The corresponding parameters of characteristics comprise Young's modulus, Poisson ratio, Yield strength, Tensile strength, Mass density, etc.

Then, the numerical material model 52 calls the material template model 54. The material template model 54 comprises an exclusive template showing the positions of the titles of the materials and the corresponding parameters of characteristics. The numerical material model 52 combines the titles of the materials and the corresponding parameters of characteristics with the exclusive template as a whole page. Then, the user interface module 24 shows the whole page.

Furthermore, the users amend the titles of the materials and the corresponding parameters of characteristics, and then the amended titles and the amended parameters of characteristics are stored in the database 32 via the numerical material model 52.

In this embodiment, the database 32 comprises the first storage section 60 and the second storage section 62. The numerical parameters and the text-type parameters, such as accounts, password, parameters of structure characteristics, titles of the material, parameters of material characteristics, are stored in the first storage section 60. The others, such as pictures, curve of the structure characteristics, are stored in second storage section 62.

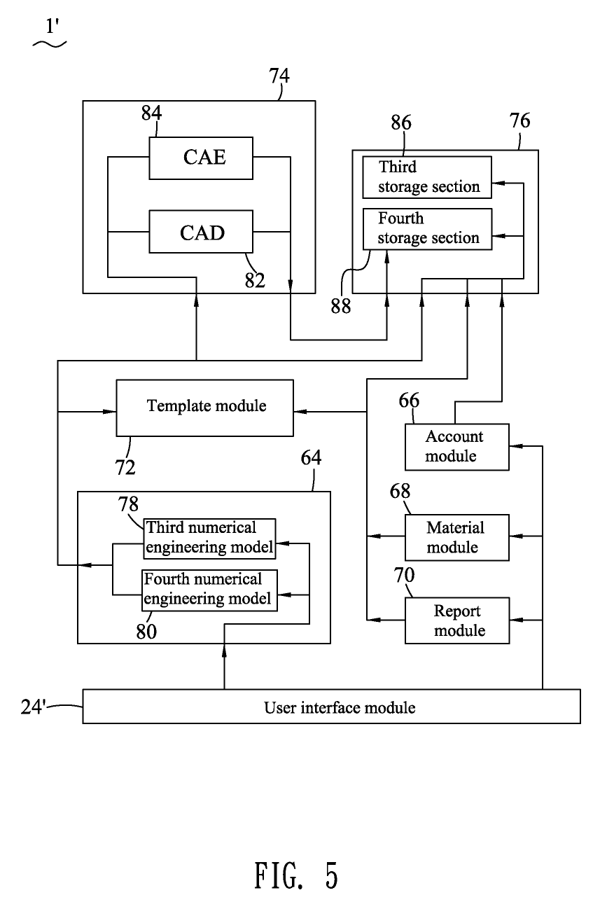

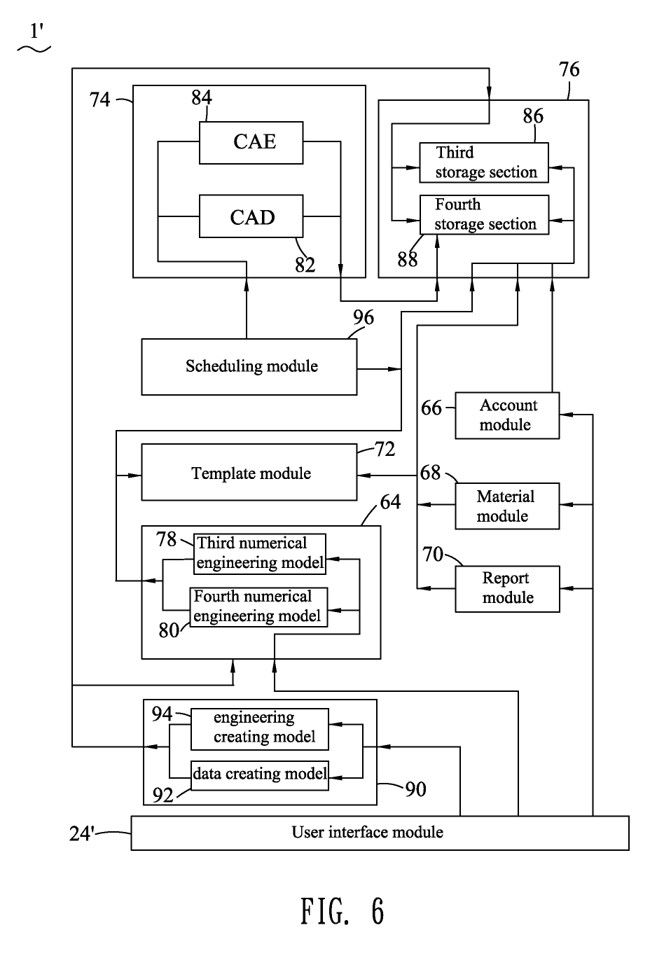

Please refer to FIG. 5, it shows a block diagram of a second preferred embodiment of the numerical engineering model system 1′. The numerical engineering model system 1′ comprises a user interface module 24′, an analyzing module 64, an account module 66, a material module 68, a report module 70, a template module 72, an engineering software means 74 and a database 76.

The analyzing module 64 has a third numerical engineering model 78 and a fourth numerical engineering model 80. The engineering software means 74 has a CAD software 82 and a CAE software 84. The database 76 has a third storage section 86 and a fourth storage section 88.

Please refer to FIG. 1, FIG. 2 and FIG. 5. The first local device 14, the second local device 16 and the third local device 18 simultaneously link to the numerical engineering model system 1′ installed in the computer server 2 via the WAN 10. The user interface module 24′ shows a login page via corresponding displays of the local device 14, 16, 18 to require an account and the corresponding password. The user input the account and password via corresponding input devices of the local device 14, 16, 18, which is acquired by the user interface module 24′ and sent to the account module 66.

The account module 66 compares the login account and password with all accounts and corresponding password stored in the database 76 to judge authority of the login user. If the login user is not accepted, the user interface module 24′ shows a warning message and re-shows the login page. If the login user is accepted, the user interface module 24′ shows an operating page. The user can select and operate the analyzing module 64, the material module 68 and the report module 70 via the operating page.

If the user selects the analyzing module 64, then the user interface module 24′ will produce a new page showing the third numerical engineering model 78 and the fourth numerical engineering model 80 built in the numerical engineering model system 1′. If the user selects the third numerical engineering model 78, then the third numerical engineering model 78 will be activated.

The third numerical engineering model 78 comprises structure characteristics and a corresponding picture. The structure characteristics, such as the length, the thickness, the curved, the material, etc, are represented as the numerical parameters. The third numerical engineering model 78 acquires the default parameters and a default picture stored in the database 76 and calls the template module 72.

The template module 72 comprises a plurality of templates. Each of the templates is corresponding to each of the modules and models. The template module 72 receives and judges the call from the third numerical engineering model 78 and then provides an exclusive template corresponding to the third numerical engineering model 78, which shows the positions of the parameters of the structure characteristics and the picture. The third numerical engineering model 78 combines the default parameters and the default picture with the exclusive template as a whole page. Then, the user interface module 24′ shows the whole page as shown in FIG. 4.

The users can amend the new parameters and select a new material according to a new design via the user interface module 24′. If the user acts an icon of start analyzing, then the third numerical engineering model 78 will store the amended parameters in the database 76 and call the engineering software means 74 for building a new 2D/3D model and then simulating and analyzing the new 2D/3D model.

The third numerical engineering model 78 calls and provides the amended parameters to the CAD software 82 for building a new 2D/3D model. Then, the 2D/3D model is stored in the database 76. The third numerical engineering model 78 calls and provides the 2D/3D model to the CAE software 84 for simulating and analyzing the new 2D/3D model, and then stores simulating reports in the database 76.

The report module 70 can shows all simulating reports and formats the simulating reports into a selected file format, such as a text file, a figure file, a html file and a combination thereof. If the report module 70 is selected via the user interface module 24′, then the user interface module 24′ will call the report module 70. The report module 70 acquires all simulating reports stored in the database 76, which comprises the amended parameters, a 2D/3D model picture, a curve of the structure characteristics, etc. Then, the report module 70 calls the template module 72.

The template module 72 receives and judges the call from the report module 70 and then provides an exclusive template corresponding to the report module 70, which shows the positions of all the simulating reports. The report module 72 combines all the simulating reports with the exclusive template as a whole page. Then, the user interface module 24′ shows the whole page. The report module 70 also sends the simulating reports to the printers 6, 20 and the plotters 8, 22 to print the simulating reports on papers.

If the material module 48 is selected via the user interface module 24, then the user interface module 24 will call the report unit 56. The report unit 56 acquires all simulating reports stored in the database 32, which comprises the amended parameters, a 2D/3D model picture, a curve of the structure characteristics, etc. Then, the report unit 56 calls the report template model 58.

The users can access and amend the parameters of material characteristics stored in the database 76 via the material module 68, if the material module 68 is selected. If the material module 68 is acted, then the material module 68 will acquire the titles of materials and the corresponding parameters of characteristics, which are stored in the database 76. For instance, the titles of materials comprise copper, iron, gold, etc. The corresponding parameters of characteristics comprise Young's modulus, Poisson ratio, Yield strength, Tensile strength, Mass density, etc.

Then, the material module 68 calls the template module 72. The template module 72 receives and judges the call from the material module 68 and then provides an exclusive template corresponding to the material module 68, which shows the positions of the titles of the materials and the corresponding parameters of characteristics. The material module 68 combines the titles of the materials and the corresponding parameters of characteristics with the exclusive template as a whole page. Then, the user interface module 24′ shows the whole page.

Furthermore, the users amend the titles of the materials and the corresponding parameters of characteristics, and then the amended titles and the amended parameters of characteristics are stored in the database 76 via the material module 68.

The numerical parameters and the text-type parameters, such as accounts, password, parameters of structure characteristics, titles of the material, parameters of material characteristics, are stored in the third storage section 86. The others, such as pictures, curve of the structure characteristics, are stored in fourth storage section 88.

Please refer to FIG. 5. The numerical engineering model system 1′ further comprises a creating module 90 and a scheduling module 92. The creating module 90 has a data creating model 92 and an engineering creating model 94. If the account module 66 judges that the login user is the administrator, then the user interface 24′ will show an operating page comprises the creating module 90. The data creating model 92 can create a new account and corresponding password, and new material title and the corresponding parameters of characteristics.

The data creating model 92 can create a data format corresponding a new data, and then store the format in the third storage section 86. The engineering creating model 94 can create a new numerical engineering model. The engineering creating model 94 can create a data format corresponding to the new numerical engineering model and then stored the data format in the third storage section 86. The engineering creating model 94 also create a new template and a new picture corresponding to the new numerical engineering model. The new picture is stored in the fourth storage section 88.

The scheduling module 96 monitors all simulating and analyzing procedures to prevent the numerical engineering model system 1′ from overloading. In this embodiment, the third numerical engineering model 78 stores the amended parameters comprising a status code in the database 76. The status code indicates the status of the simulating and analyzing procedure. The status code can indicate the preparing status, the running status, the finished status and the error status.

The scheduling module 96 can acquire the status codes of the simulating and analyzing procedures and arrange an appropriate schedule. For instance, if all the status codes indicating the running status are below a threshold, then the scheduling module 96 will arrange one of the preparing procedures into running and amends the procedure into the running status. If the simulating and analyzing procedure is finished, then the scheduling module 96 will amend the procedure into the finished status.

Furthermore, the numerical engineering model system 1, 1′ is not limited to apply to an electrical connector product. The numerical engineering model system 1, 1′ can apply to PCB products, cable products, antenna products, battery products, etc.

As described above, the numerical engineering model system 1, 1′ has the following advantages. Because the numerical engineering model system 1, 1′ is configured in the network, the users can remotely operate the numerical engineering model system 1, 1′ via any computer with network function. The engineering models are presented as numerical parameters and corresponding picture to simplify the design procedures and reduce the design cost. Furthermore, it is easy to understand and operate for the common users without engineering knowledge.

The template models and template module can provide a plurality of templates. Each of the templates is unique for each of the modules and models. It is convenient for the user to amend individual template, individual model and individual module without considering the other templates, models and modules. The simulating and analyzing reports are stored in the database 32, 76. The users can refer and manage all simulating and analyzing reports via the report module 50, 70. It may rapidly copy and share success experiences to reduce design time.

Furthermore, the present invention is not limited to the embodiments described above; diverse additions, alterations and the like may be made within the scope of the present invention by a person skilled in the art. For example, respective embodiments may be appropriately combined.

What is claimed is:

1. A numerical engineering model system installed in a computer server and being remotely operated by a local device via a network linking the computer server and the local device, comprising:
a user interface for showing an operating page by an output apparatus of the local device and receiving the numerical parameters inputted by an input apparatus of the local device;
an analyzing module having at least one engineering model, the engineering model being represented as the numerical parameters and a corresponding picture;
a database called by the analyzing module for storing the inputted numerical parameters and the picture; and
an engineering software means called by the analyzing module for processing the inputted numerical parameters and then building one of a 2D model and a 3D model and simulating and analyzing one of the 2D model and the 3D model and storing 2D model, the 3D model, a simulating result and an analyzing result in the database, the stored in the database.

2. The numerical engineering model system claimed in claim 1, further comprising a template module having an exclusive template, the exclusive template recording view positions of the numerical parameters and the picture of the engineering model.

3. The numerical engineering model system as claimed in claim 2, further comprising a material module acquiring default material titles and the default material parameters and storing the inputted the numerical parameters as material parameters in the database.

4. The numerical engineering model system as claimed in claim 3, further comprising a report module acquiring at least one of the 2D model and the 3D model, the simulating result, the analyzing result, the numerical parameters and the picture and formatting a report as a selected file.

5. The numerical engineering model system as claimed in claim 4, wherein the selected file is one of a text file, a picture file, a html file and a combination thereof.

6. The numerical engineering model system as claimed in claim 4, further comprising an account module judging authority of user login the numerical engineering model system.

7. The numerical engineering model system as claimed in claim 6, wherein the database comprises a first storage section and a second storage section, the first storage section stores the numerical parameters and the titles of the material, the second storage section stores the picture, the 2D model and the 3D model.

8. The numerical engineering model system as claimed in claim 5, wherein the engineering software means comprises a CAD software for building the 2D model and a CAE software for building the 3D model and simulating and analyzing at least one of the 2D model and the 3D model.

9. The numerical engineering model system as claimed in claim 8, further comprising a multi-thread function for simultaneously processing a plurality of links of login user.

10. The numerical engineering model system as claimed in claim 9, further comprising a scheduling module for monitoring and scheduling the procedures of simulating and analyzing one of the 2D model and the 3D model.

11. The numerical engineering model system as claimed in claim 9, further comprising a creating module for creating a new engineering model and a new account and the new material parameters.

12. A method for accessing a numerical engineering model system installed in a terminal server linking to a network, comprising:
linking with the terminal server via a local device;
login the numerical engineering model system by an account means for judging the authority of a login user;
showing an user interface means via an output apparatus of the local device;
inputting the numerical parameters to the user interface means via a input apparatus of the local device, the numerical parameters representing the structure of an engineering model;
storing the inputted numerical parameters in a database;
building at least one of a 2D model and a 3D model based on the inputted numerical parameters by an engineering software means;
simulating and analyzing at least one of the 2D model and the 3D model by the engineering software means;
processing a simulating result and an analyzing result by the engineering software means; and
storing the simulating result and the analyzing result in the database.

13. The method as claimed in claim 12, wherein the numerical parameters comprises the material of the engineering model.

14. The method as claimed in claim 13, further comprising amending the material via the user interface means.

15. The method as claimed in claim 14, further comprising formatting at least one of the 2D model and the 3D model, the numerical parameters, the simulating result and the analyzing result into a selected file.

16. The method as claimed in claim 15, further comprising storing the numerical parameters in a first storage section of the database and storing at least one of the 2D model and the 3D model, the simulating result and the analyzing result in a second storage section of the database.

17. The method as claimed in claim 16, further comprising building the 2D model by a CAD software of the engineering software means, and building the 3D model by a CAE software, and simulating and analyzing at least one of the 2D model and the 3D model by the CAE software of the engineering software means.

18. The method as claimed in claim 17, further comprising a multi-thread means for simultaneously processing requirements of the login user.

19. The method as claimed in claim 18, further comprising monitoring the procedures of simulating and analyzing required by a plurality of login users, and scheduling the procedures if the procedures of simulating and analyzing are below a threshold.

20. The method as claimed in claim 19, comprising creating a new engineering model and a new account if the authority of the login user is judged as the administrator.
